(19) United States
(12) Patent Application Publication
(10) Pub. No.: US 2005/0057233 A1
(43) Pub. Date: Mar. 17, 2005

(54) Current control circuit, semiconductor device and image pickup device

(75) Inventors: Makoto Miyamura, Kyoto (JP); Kiminori Takemasa, Kyoto (JP)

Correspondence Address: MORGAN LEWIS & BOCKIUS LLP, 1111 PENNSYLVANIA AVENUE NW, WASHINGTON, DC, 20004, US

(73) Assignee: ROHM CO., LTD.

(21) Appl. No.: 10/927,595

(22) Filed: Aug. 27, 2004

(30) Foreign Application Priority Data
Aug. 28, 2003 (JP) P. 2003-304084
Jun. 22, 2004 (JP) P. 2004-183336

(51) Int. Cl. G05F 1/40

(52) U.S. Cl. 323/268

(57) ABSTRACT

A current control circuit comprises a first NMOS for controlling a current supplied to a load connected to a drain; a second NMOS, the gate of which is connected to a gate of the fist NMOS; a resistor connected between the drain of the second NMOS and the power source; and an operational amplifier, the first input terminal of which is connected between the drain of the second NMOS and the resistor, to the second input terminal of which a control signal for adjusting an intensity of the current supplied to the load is inputted, the output of which is connected to a common connection point between the gates of the first NMOS and the second NMOS.

### BACKGROUND OF THE INVENTION

1. Field of the Invention

The present invention relates to a current control circuit, semiconductor device, and image pickup device into which the current control circuit and semiconductor device are incorporated. More specifically, the present invention relates to appropriately control motors which are used as actuators for controlling a lens of the image pickup device such as actuators for zooming, focusing and iris controlling.

2. Description of the Related Art

In order to obtain the phase information of a coil used for a motor which conducts lens control of an image pickup device, a hall element is used. The sensitivity of the hall element, which determines an intensity of voltage detected by the hall element according to a change in the magnetic field received by the hall element, is adjusted by adjusting an intensity of the current, which is made to flow in the hall element. However, the characteristic of the hall element greatly depends on each product. Further, the characteristic of the hall element is changed by the external environment such as an atmospheric temperature. Therefore, in order to maintain the hall element characteristic constant, it is necessary to adjust an intensity of the current, which is made to flow in the hall element, each time the electric power source is started.

Explanations will be made into a related-art current adjusting method of adjusting an intensity of the current which is made to flow in the hall element. In the related art, an intensity of the current is adjusted as follows. As shown in FIG. 1, a digital signal, which is a control signal for making a predetermined intensity of current flow from CPU of the image pickup device into the hall element 6, is inputted into DAC (Digital/Analog Converter) 7. This digital control signal is converted into an analog control signal by DAC 7. The analog control signal, which is an output from DAC 7, is subjected to potential-division by resistors R1 and R2, which are impedance elements, and inputted into an operational amplifier 4. Since an output of the operational amplifier 4 is a gate voltage of NMOS (N type MOS transistor) 5 which is a current control element, the gate voltage of NMOS 5 is adjusted by the digital control signal sent from CPU of the image pickup device, so that an intensity of the current made to flow in the hall element 6 can be adjusted.

In the case where NMOS 5 is operated in the saturated region, the following equation is established.
V_{g}=V_{gs}+R3 Ω×I_{ds} (Equation 1)
where the gate voltage of NMOS 5 is V_{g}, the voltage between the gate and source of NMOS 5 is V_{gs}, the current flowing between the drain and source of NMOS 5 is I_{ds}, and the resistance of resistor R3 is R3 Ω.

In the saturated region, the fundamental operating equation of a transistor is expressed as follows.
I_{ds}=K(V_{gs}−Vₜ)² (Equation 2) (K: Constant)

Therefore, according to Equations 1 and 2, the following equation is established.
V_{g}=V_{gs}+R3 Ω×K(V_{gs}−Vₜ)² (Equation 3)

Since V_{g}, R3 Ω and Vₜ are constants, V_{gs} can be calculated. In this case, in Equation 1, R3 Ω×I_{ds} is potential VA at point A. Therefore, an intensity of the current flowing in the hall element 6 is determined by potential VA at point A, which is determined by the gate voltage of NMQS 5, and by resistance R3.

Next, descriptions will be made into the necessity that resistor R3 is connected to the source side of NMOS 5. As described above, an intensity of the current flowing in the hall element 6, which is a load, is determined by potential VA at point A and resistance R3 Ω of resistor R3. Equation I=(VA/R3 Ω) is established, wherein the intensity of the current at point A is I. Since the characteristic of the hall element is sharp, control can be conducted by a step width of a minute intensity of the current. Therefore, resistor R3 is necessary to adjust an intensity of the current made to flow in the hall element. The resistance value of resistor R3 must be somewhat high.

Next, descriptions will be made into the necessity of dividing the potential of the digital signal which is sent from CPU of the image pickup device. In the case shown in the drawing, the potential is divided by resistors R1 and R2. In order to linearly operate DAC 7 with high accuracy, it is preferable that the power source voltage 8 (AVDD) of DAC 7 is high, because the occurrence of miscode can be prevented. However, since the sensitivity of the hall element 6 is high and the characteristic of the hall element 6 is sharp, control is conducted by a step width of a minute current. When the resistance value of resistor R3 is R3 Ω and the intensity of the current at point A is I, the equation I=(VA/R3 Ω) is established. Therefore, in order to conduct controlling by a step width of a minute current, it is necessary that the potential of the step width of the output voltage of DAC 7 is divided and level-shifted to voltage appropriate for controlling the hall element 6. For the above reasons, the output voltage of DAC 7 is divided.

Next, problems caused by resistor R3 will be described below, and problems caused when potential is divided by resistors R1 and R2 will be also described below. When a high intensity of the current is made to flow in the hall element 6, potential VA at point A is raised by the voltage generated by the current flowing in resistor R3, and voltage (V_{ds}) between the drain and source of NMOS 5 is compressed. The potential from the voltage on the drain side of NMOS 5 to the ground via resistor R3 necessarily becomes lower than the power source voltage 8 since the hall element 6 is connected to it. In this case, in order to simplify the explanations, it is assumed that the potential from the drain side of NMOS 5 to the ground via resistor R3 must be fixed at ½ AVDD which is ½ of the power source voltage 8. As shown in FIG. 2, when voltage VR generated by resistor R3 is increased, Vds necessary for operating NMOS 5 in the saturated region is compressed. Therefore, NMOS, which must be operated in the saturated state, is operated in the non-saturated state. Accordingly, only a portion of the output range of the output voltage of DAC 7 can be utilized as a variable width of potential VA at point A for adjusting the intensity of the current made to flow in the hall element 6. That is, resistor R3 is necessary for adjusting the intensity of the current made to flow in the hall element 6, that is, resistor R3 must be attached to the source side of NMOS 5 (Refer to page 3, line 1—page 4, line 25), however, Vds of NMOS 5 is compressed at the time of the generation of the current. Therefore, it is impossible to extend a variable width of voltage VA which determines the intensity of the current flowing in the hall element (The above is defined as Problem “a”.).

When the potential is divided by resistors R1 and R2, as shown in FIG. 2, the following phenomenon is caused. In FIG. 2, item (1) is a reduced view of the related-art current control circuit shown in FIG. 1, item (2) is a graph for showing an output range of the voltage in the output voltage of DAC 7 capable of being used, item (3) is a graph showing a relation between the input voltage inputted into the operational amplifier 4 and the offset of the operational amplifier 4, and item (4) is a graph showing a voltage generated in a range between the power source voltage 8 (AVDD) and the ground (GND). When the output voltage of DAC 7 is inputted into the operational amplifier 4, the potential is divided by resistors R1 and R2. However, since the offset voltage (the amplifier offset shown by the graph (3) in FIG. 2) of the operational amplifier 4 is not compressed, the offset voltage of the operational amplifier 4 can not be neglected. Further, the step width of the output voltage of DAC 7 is approximately ((AVDD—Offset voltage of DAC 7)/(Number of digital signals sent from CPU of image pickup device)). At the time of a reduction of electric power, it is necessary to conduct DA conversion (Digital/Analog Conversion) on the number of levels of intensity operation, which is sent from CPU of the image pickup device, by a low power source voltage. Therefore, the step width of the output voltage of DAC 7 is reduced. Accordingly, the output of DAC 7 loses the linearity by miscode. Further, when the potential is divided by the resistors, dispersion is caused by the resistors. Accordingly, the digital signal sent from CPU of the image pickup device can not be accurately added to the gate voltage of NMOS 5 (The above is defined as Problem “b”.)

### SUMMARY OF THE INVENTION

In view of the actual circumstances described above, the present invention has been accomplished to solve Problems “a” and “b” described before. A first object of the present invention is to provide a current control circuit in which an intensity of the current supplied to a load such as a hall element is adjusted by an accurate and minute step width; no compression is caused in the bias voltage of the current control element connected to the hall element; and it is unnecessary to divide the potential so as to obtain a control voltage for operating a current control element such as NMOS. A second object of the present invention is to provide a semiconductor device into which the above current control circuit is incorporated. A third object of the present invention is to provide an image pickup device on which the above semiconductor device is mounted.

In order to achieve the first object of the present invention, there is provided a current control circuit, according to a first aspect of the present invention, comprising:
a first current control element for controlling a current supplied to a load;
a second current control element, a control terminal of which is connected to a control terminal of the first current control element;
an impedance element connected between a power source and a terminal of the second current control element on a power source side; and
an operational amplifier having a first input terminal, a second input terminal and an output, the first input terminal being connected to between the terminal of the second current control element on the power source side and the impedance element, the second input terminal being inputted a control signal for adjusting an intensity of current supplied to the load, the output being connected to a common connection point of the first current control element and the second current control element.

Further, to achieve the first object of the present invention, there is provided a current control circuit, according to a second aspect of the present invention, comprising:
a first current control element for controlling a current supplied to a load;
a second current control element, a control terminal of which is connected to a control terminal of the first current control element; and
an operational amplifier having a non-inversion input terminal, an output terminal and an inversion input terminal, the non-inversion input terminal being connected to one of electrodes of the second current control element, the output terminal being connected to the respective control terminals of the first current control element and the second current control element, the inversion input terminal being connected to a control signal, wherein an intensity of the current supplied to the load is adjusted by the control signal.

To achieve the first object of the present invention, there is provided a current control circuit, according to a third aspect of the present invention, comprising:
a first series connection body having a load and a first current control element;
a second series connection body having an impedance element and a second current control element, the second series connection body being connected to the first series connection body in parallel; and
an operational amplifier having a non-inversion input terminal, an inversion input terminal and an output end, the non-inversion input terminal being connected to a connection point of the impedance element of the second series connection body and the second current control element, the inversion input terminal being connected to an output end of the control signal, the output end being connected to a common connection point of the respective control terminals of the first current control element and the second current control element.

In the current control circuit according to one of the first to third aspects of the present invention, according to a fourth aspect of the present invention, the current control element is NMOS.

In the current control circuit according to the first aspect of the present invention, according to a fifth aspect of the present invention, each of the first and second current control elements is NMOS, the control terminal of each of the first and second current control elements is gate of NMOS, the terminal of the second current control element on the power source side is drain of NMOS, the impedance element is resistor, and the first current control element has a drain of NMOS connected to the load.

In the current control circuit according to one of the first to fifth aspects of the present invention, according to a sixth aspect of the present invention, the load is a hall element.

In the current control circuit according to one of the first to sixth aspects of the present invention, according to a seventh aspect of the present invention, an output voltage sent from DAC is inputted into the inversion input terminal of the operational amplifier.

In order to achieve the second object of the present invention, there is provided a semiconductor device, according to an eighth aspect of the present invention, comprising a current control circuit according to one of the first to seventh aspects of the present invention.

In order to achieve the third object of the present invention, there is provided an image pickup device, according to a ninth aspect of the present invention, comprising: a semiconductor device according to the eighth aspect of the present invention; and a hall element connected to the semiconductor device.

A low voltage operation can be realized in which it is not necessary to divide the potential of the output signal sent from CPU of the image pickup device, an intensity of the current made to flow in the hall element can be accurately controlled even in the case of a reduction of electric power, and the power source voltage connected to the hall element is not higher than the related-art power source voltage.

### BRIEF DESCRIPTION OF THE DRAWINGS

FIG. 1 is a related-art current control circuit;

FIG. 2 show a reduced view of the related-art current control circuit (item (1)), a graph showing an output range of the usable voltage in the output voltage of DAC 7 (item (2)), a graph showing a relation between the input voltage into the operational amplifier 4 and the offset of the operational amplifier 4 (item (3)), and a graph showing a voltage generated between the power source voltage 8 (AVDD) and the ground (GND) (item (4));

FIG. 3 is a current control circuit of the present invention;

FIG. 4 is a reduced view of the current control circuit of the present invention shown in FIG. 3 (item (1)), a graph showing an output range of the usable voltage of the output voltage of DAC 7 (item (2)), a graph showing a voltage generated in the series connection body from the power source voltage AVDD to the ground GND (item (3)), and a graph showing a voltage generated between the power source voltage AVDD and the ground GND via the load (item (4)); and

FIG. 5 is an image pickup device of the present invention.

### DETAILED DESCRIPTION OF THE INVENTION

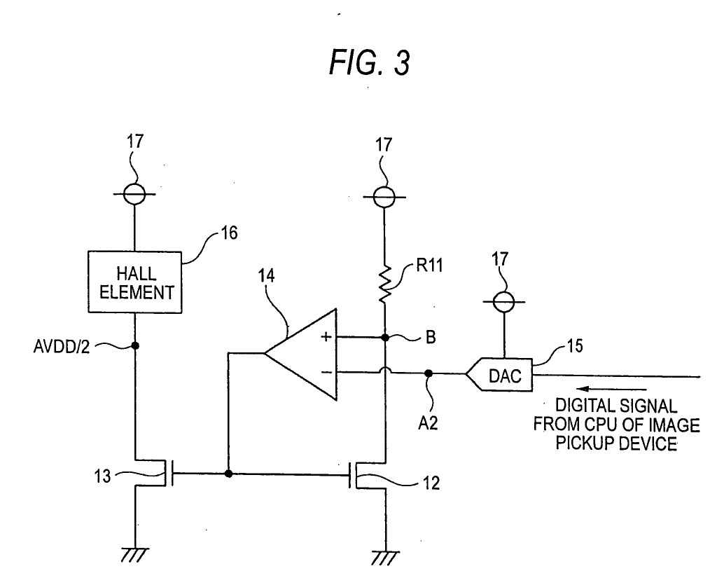

In the present invention, as shown in FIG. 3, an output of DAC 15 is inputted into the inversion input terminal of an operational amplifier 14. The potential at point B, which is determined by the voltage dropped by the current flowing from the power source voltage 17 to resistor R11, is inputted into the non-inversion input terminal of the operational amplifier 14. Therefore, the output voltage of the operational amplifier 14 is controlled by the input signal inputted into both terminals of the operational amplifier 14. The output voltage of the operational amplifier 14 is connected to the gate of NMOS (N type MOS transistor) 12. By the output voltage of the operational amplifier 14, that is, by the gate voltage of the NMOS 12, an intensity of the electric current flowing in resistor R11 is determined. By the power source voltage (AVDD) 17 and also by the voltage (VR2) generated by the current flowing in resistor R11 and also by the potential between the drain and source of NMOS 12, the potential of the non-inversion input terminal of the amplifier 14 is determined. Since the gate of NMOS 13 and the gate of NMOS 12 are common, an intensity of the current flowing in the hall element 16 is determined by the output voltage of DAC 15, that is, by the digital signal sent from CPU of the image pickup device.

For example, when a digital signal for decreasing an intensity of the current flowing in the hall element 16 is inputted from CPU of the image pickup device into the inversion input terminal of the operational amplifier 14 via DAC 15, the output voltage of the operational amplifier 14 is low as compared with a case in which a digital signal for increasing the intensity of the current flowing in the hall element 16 described later is sent from CPU of the image pickup device, and the gate voltage of NMOS 12 and the gate voltage of NMOS 13 are increased a little. Therefore, a low intensity of the current flows in the hall element 16 compared with a case in which the digital signal is sent from CPU of the image pickup device so as to increase the intensity of the current of the hall element 16 described later. In this connection, at this time, an intensity of the current flowing in resistor R11 is decreased, and the voltage (VR2) generated by resistor R11 is decreased as compared with a case before a change in the input from CPU of the image pickup device. The voltage of (AVDD 17−VR2−V_{ds}) is inputted into the non-inversion input terminal of the operational amplifier 14. Therefore, the operational amplifier 14 is subjected to feedback control and operated stably. In order to increase an intensity of the current flowing in the hall element 16, a digital signal of a high voltage is inputted from CPU of the image pickup device into the inversion input terminal of the operational amplifier 14 via DAC 15. Then, the output voltage of the operational amplifier 14 is greatly amplified. Alternatively, compared with the aforementioned case in which the digital signal to decrease an intensity of the current flowing in the hall element 16 is inputted, a high output is outputted from the operational amplifier 14, and the gate voltage of NMOS 12 and the gate voltage of NMOS 13 are increased. Therefore, compared with the aforementioned case in which a digital signal to decrease the intensity of the current flowing in the hall element 16 is sent from CPU of the image pickup device, a high intensity of the current flows. In this connection, at this time, an intensity of the current flowing in resistor R11 is also increased, and the voltage (VR2) generated by resistor R11 is increased. The voltage of (AVDD 17−VR2−V_{ds}) is inputted into the non-inversion input terminal of the operational amplifier 14, and the operational amplifier is subjected to feedback control and operated stably.

Next, how the above problems “a” and “b” have been solved will be described below while a comparison is being made between the current control circuit of the present invention and the related-art current control circuit.

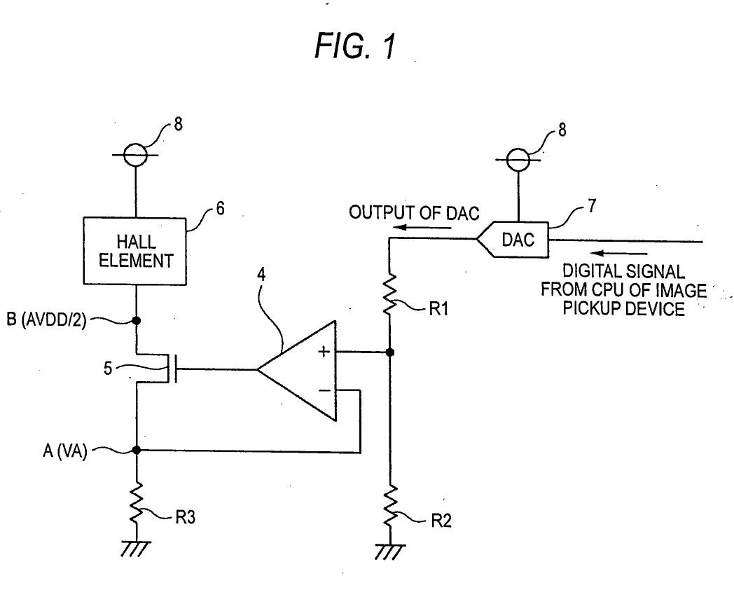

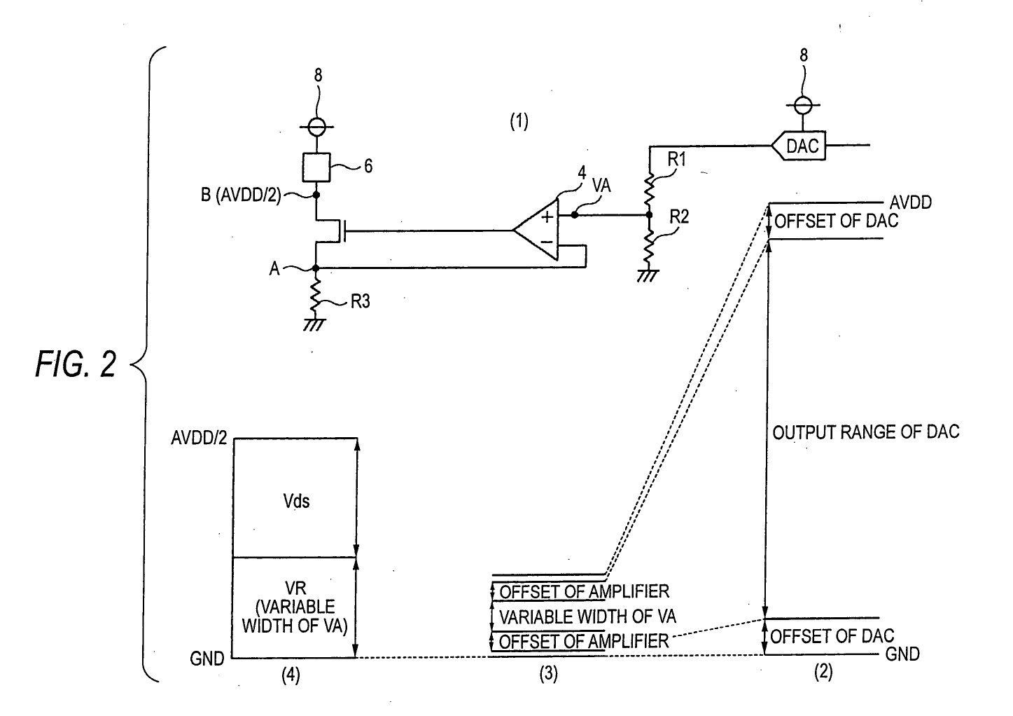

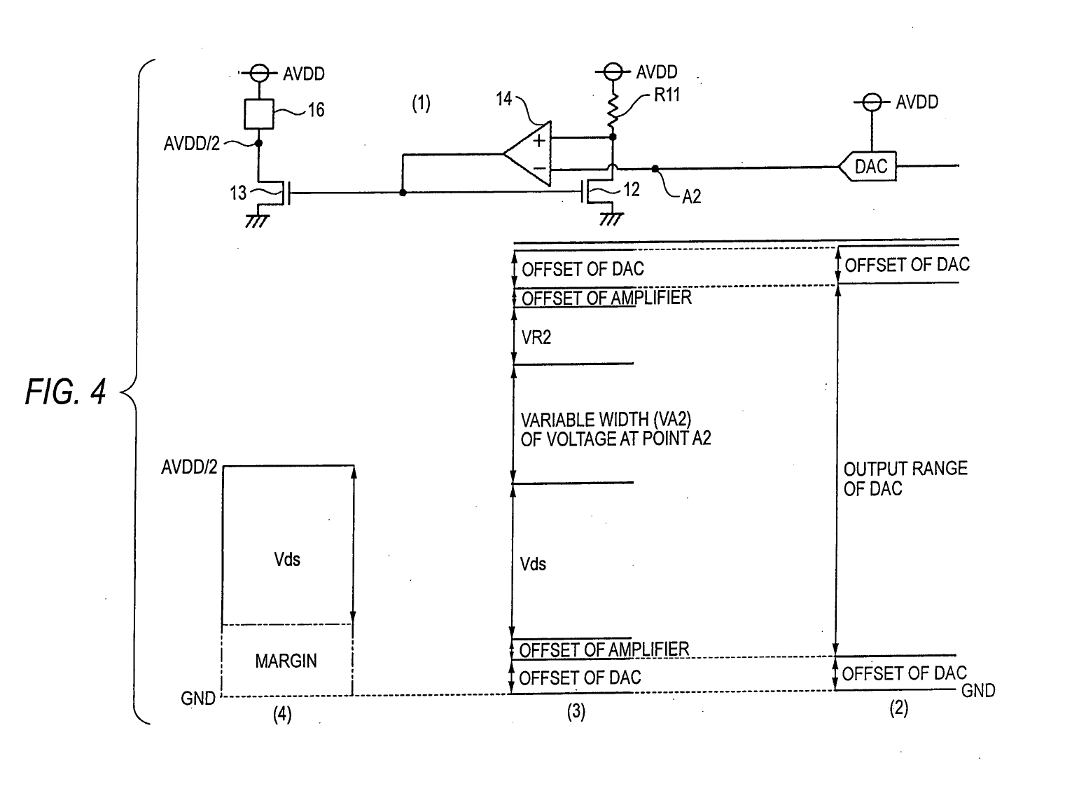

Resistor R3, which is provided for adjusting an intensity of the current flowing in the hall element 6 in the related-art current control circuit shown in FIG. 1, is provided on the drain side of NMOS 12 in the current control circuit of the present invention shown in FIG. 3 as resistor 11 (Means 1 for Solving the Problem “a”). Even in the case where a high intensity of the current flows in resistor R11 and a high voltage is generated in resistor R11, in the series connection body in which the hall element 16 of the load is provided, as shown in the graph (3) of FIG. 4, as compared with the graph (3) of FIG. 2 which is the voltage characteristic of the related-art current control circuit, the voltage (corresponding to VR shown in the graph (4) of FIG. 2) to compress voltage V_{ds} between the drain and source of NMOS connected to the hall element is not generated. Therefore, as shown in the graph (4) of FIG. 4, the margin can be extended (Effect 1). In this connection, item (1) in FIG. 4 is a reduced view of the current control circuit of the present invention shown in FIG. 3, item (2) in FIG. 4 is a graph showing an output range of the usable voltage of the output voltage of DAC 7, item (3) in FIG. 4 is a graph showing a voltage generated in the series connection body from the power source voltage AVDD to the ground GND, and item (4) in FIG. 4 is a graph showing a voltage generated between the power source voltage AVDD and the ground GND via the load. In this connection, voltage VR, which is generated by resistor R3 for adjusting an intensity of the current flowing in the hall element 6 in FIG. 2, corresponds to voltage VR2 generated in resistor R11 for adjusting an intensity of the current flowing in the hall element 16 shown in the graph (3) of FIG. 4.

In the related-art current control circuit shown in FIG. 1, the potential on the drain side of NMOS 5, which generates a voltage in resistor R3 for adjusting an intensity of the current flowing in the hall element 6, necessarily becomes lower than the power source voltage 17 on the drain side of NMOS 13 because the hall element 16 is connected to it. In the current control circuit of the present invention shown in FIG. 3, on the drain side of NMOS 12, which is formed into a current mirror structure, the gate voltage of which is the same as the gate voltage of NMOS 13 connected to the hall element 16 of the load, a new power source voltage (AVDD) 17, which need not to be fixed lower than the power source voltage, is additionally provided (Means 2 for Solving the Problem “a”). Therefore, voltage V_{ds} (Refer to the graph (3) in FIG. 4.) between the gate and source of NMOS 12 used for adjusting the current can be made higher than V_{ds} of NMOS 5 of the related-art current control circuit shown in the graph (4) of FIG. 2. Therefore, compared with the related-art NMOS 5 for adjusting the current shown in FIG. 1, NMOS 12 for adjusting the current of the present invention shown in FIG. 3 has a wide variable width VA2 of the voltage until it operates in the non-saturated region. In other words, the power source voltage connected to the hall element can be designed at a low value (Effect 2).

In the current control circuit of the present invention, according to the above effects 1 and 2, compared with the current control circuit shown in FIG. 2, as shown in FIG. 4, the variable width of potential VA2 at point A2, which is a control voltage for adjusting a current flowing in the hall element, can be utilized being extended. In the current control circuit of the present invention shown in FIG. 3, since V_{ds} is not compressed in the series connection body including the hall element 16 of the load, as shown by the margin portion in the graph (3) of FIG. 4, since operation can be conducted even when the power source voltage (AVDD) 17 is set at a low value, a low voltage operation can be realized.

In the current control circuit of the present invention shown in FIG. 3, the output voltage outputted from DAC 15 is not divided (Means 2 for Solving the Problem “b”). Therefore, as shown in the graph (2) of FIG. 4, the output range of DAC 15 can be substantially fully used and inputted into the operational amplifier 14. Due to the foregoing, digital signals sent from CPU of the image pickup device can be accurately converted into voltage and inputted into the operational amplifier 14. (According to the related-art case, there is a possibility of the occurrence of miscode.) As a result, the gate voltage of NMOS 13 can be accurately controlled in a wide guaranteed range (Effect 3). In other words, a variable range of potential VA2 at point A2 shown in FIG. 3 can be extended. Therefore, it is possible to extend the guaranteed range in which an intensity of the current flowing in the hall element 16 is accurately adjusted. This effect can be remarkably exhibited especially at the time of a reduction in electric power.

In this connection, a ratio of the gate area of NMOS 13 to the gate area of NMOS 12 of the current control circuit of the present invention is set at 5:1, however, it should be noted that the present invention is not limited to the above specific ratio. The ratio of the gate area of NMOS 13 to the gate area of NMOS 12 can be appropriately changed according to the intensity of the current which is made to flow in the hall element 16.

The current control circuit of the present invention is singly incorporated being sealed, and formed into a semiconductor device. Alternatively, the current control circuit of the present invention is incorporated together with another circuit having another function being sealed, and formed into a semiconductor device.

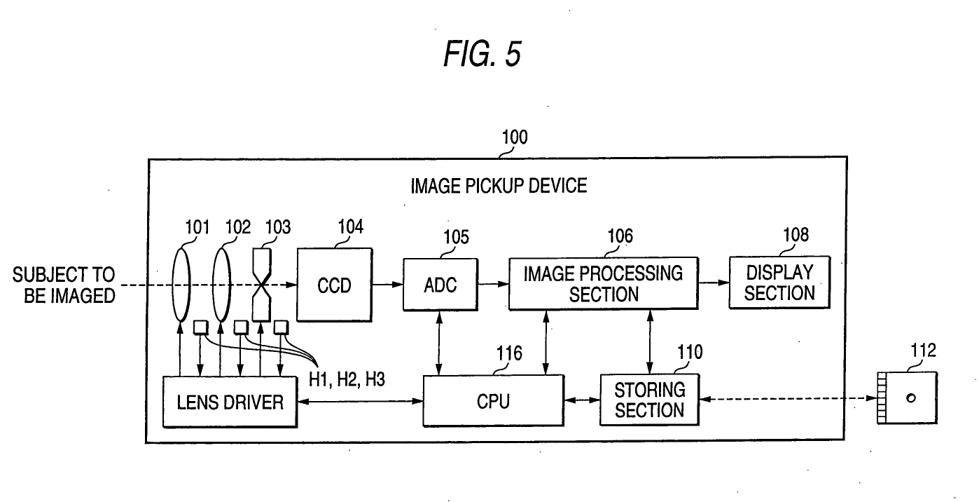

FIG. 5 is a view showing an image pickup device into which the semiconductor device having the current control circuit of the present invention is incorporated. In the drawing, the image pickup device 100 includes: a zoom lens 101, focus lens 102, iris 103, CCD 104, ADC 105, image processing section 106, display section 108, storing section 110, hall elements H1, H2, H3, and other parts not shown in the drawing. In this connection, the external storing medium body 112 is used for extending a storing region of the storing section 110.

In the drawing, an image of the subject to be imaged is converted into digital data by CCD 104 and ADC 105 via the zoom lens 101, focus lens 102 and iris 103. The thus converted digital data is processed by the image processing section 106 and then displayed by the display section 108. The storing section 110 or the external storing medium body 112 stores an image processed by the image processing section 106. The semiconductor device provided with the current control circuit of the present invention is arranged in the lens driver section, and the hall elements H1, H2, H3 respectively send signals showing the states of the zoom lens 101, focus lens 102 and iris 103. When these signals are received by the lens driver, the zoom lens 101, focus lens 102 and iris 103 are controlled.

In this image pickup device, it is possible to reduce a power source voltage used for the hall element. Therefore, the power consumption can be reduced.

It should be noted that the present invention is not limited to the above specific embodiments. All variations made by those skilled in the art within the range described in the claim are included in the present invention. For example, MOS type transistor may be replaced with a bipolar transistor. The input signal into the operational amplifier is not necessarily limited to the control voltage which is an output of DAC, and the load is not limited to the hall element. It is possible to employ the constitution in which the inversion input terminal and the non-inversion input terminal of the operational amplifier are reversed to each other and an inverter are connected to the output. Of course, the semiconductor device of the present invention is applied to not only an image pickup device but also a video image pickup device or a vehicle, the operation of which is electrically controlled.

1. A current control circuit comprising:
a first current control element for controlling a current supplied to a load;
a second current control element, a control terminal of which is connected to a control terminal of the first current control element;
an impedance element connected between a power source and a terminal of the second current control element on a power source side; and
an operational amplifier having a first input terminal, a second input terminal and an output end, the first input terminal being connected to between the terminal of the second current control element on the power source side and the impedance element, the second input terminal being inputted a control signal for adjusting an intensity of current supplied to the load, the output end being connected to a common connection point of the first current control element and the second current control element.

2. A current control circuit comprising:
a first current control element for controlling a current supplied to a load;
a second current control element, a control terminal of which is connected to a control terminal of the first current control element; and
an operational amplifier having a non-inversion input terminal, an output terminal and an inversion input terminal, the non-inversion input terminal being connected to one of electrodes of the second current control element, the output terminal being connected to the respective control terminals of the first current control element and the second current control element, the inversion input terminal being connected to a control signal, wherein an intensity of the current supplied to the load is adjusted by the control signal.

3. A current control circuit comprising:
a first series connection body having a load and a first current control element;
a second series connection body having an impedance element and a second current control element, the second series connection body being connected to the first series connection body in parallel; and
an operational amplifier having a non-inversion input terminal, an inversion input terminal and an output end, the non-inversion input terminal being connected to a connection point of the impedance element of the second series connection body and the second current control element, the inversion input terminal being connected to an output end of the control signal, the output end being connected to a common connection point of the respective control terminals of the first current control element and the second current control element.

4. A current control circuit according to claim 1, wherein the current control element is NMOS.

5. A current control circuit according to claim 2, wherein the current control element is NMOS.

6. A current control circuit according to claim 3, wherein the current control element is NMOS.

7. A current control circuit according to claim 1, wherein each of the first and second current control elements is NMOS, the control terminal of each of the first and second current control elements is gate of NMOS, the terminal of the second current control element on the power source side is drain of NMOS, the impedance element is resistor, and the first current control element has a drain of NMOS connected to the load.

8. A current control circuit according to claim 1, wherein the load is a hall element.

9. A current control circuit according to claim 2, wherein the load is a hall element.

10. A current control circuit according to claim 3, wherein the load is a hall element.

11. A current control circuit according to claim 1, wherein an output voltage sent from DAC is inputted into the second input terminal of the operational amplifier.

12. A current control circuit according to claim 2, wherein an output voltage sent from DAC is inputted into the inversion input terminal of the operational amplifier.

13. A current control circuit according to claim 3, wherein an output voltage sent from DAC is inputted into the inversion input terminal of the operational amplifier.

14. A semiconductor device comprising a current control circuit according to claim 1.

15. A semiconductor device comprising a current control circuit according to claim 2.

16. A semiconductor device comprising a current control circuit according to claim 3.

17. An image pickup device comprising: a semiconductor device according to claim 14; and a hall element connected to the semiconductor device.

18. An image pickup device comprising: a semiconductor device according to claim 15; and a hall element connected to the semiconductor device.

19. An image pickup device comprising: a semiconductor device according to claim 16; and a hall element connected to the semiconductor device.
